(19) United States
(12) Patent Application Publication
(10) Pub. No.: US 2019/0108512 A1
(43) Pub. Date: Apr. 11, 2019

(54) TOKEN-BASED WEB AUTHORIZED SPLIT TRANSACTIONS

(71) Applicant: MasterCard International Incorporated, Purchase, NY (US)

(72) Inventors: Cristian Radu, Beauvechain (BE); Annapoorani Kannan, O'Fallon, MO (US); Alan Johnson, Salcott Maldon (GB)

(21) Appl. No.: 15/730,252

(22) Filed: Oct. 11, 2017

(51) Int. Cl. G06Q 20/36; G06Q 20/20; G06Q 20/40; G06Q 20/22

(52) U.S. Cl. CPC G06Q 20/367; G06Q 20/204; G06Q 20/0855; G06Q 20/22; G06Q 20/407

(57) ABSTRACT

A payment card account system transaction takes place at a provider. A payment card account system transaction authorization request message is transmitted from the provider to a transaction processor. Details of the transaction are transmitted via an internet protocol message from the provider to a rebate processor.

### BACKGROUND

There are a number of types of situations in which consumers or others may be entitled to full or partial reimbursement for certain expenditures that they make. One very common type of expenditure is for medical services. Many consumers may be covered by health insurance that may provide partial or complete reimbursement for medical service charges. In some insurance arrangements, the consumer is required to pay the medical service provider and at that time obtains a paper certificate proving that the payment has been made. The consumer then must submit a claim to the medical insurance company, including the paper proof of payment. This type of arrangement entails a high degree of inconvenient manual processing of paper documents on the part of both the consumer and the insurer.

In other arrangements, the consumer receives an “explanation of benefits” (EOB) on paper from the medical insurance company. The EOB is in response to a claim submitted to the insurance company from the medical services provider. The EOB contains an explanation (often difficult for the consumer to decipher) of what the provider's charges were, how much of the amount charged was disallowed or covered by insurance benefits, and the amount payable from the consumer to the medical service provider. The consumer must then pay to the medical services provider an amount billed by the medical services provider in accordance with the EOB. Among many other inconveniences and inefficiencies in this system, the consumer may be required to retain the paper EOB and to compare it with the subsequently received invoice from the medical services provider. Again this type of system entails a high degree of labor-intensive activity on the part of the consumer and other parties.

It is also common to encounter inefficient and labor-intensive practices in other situations, such as reimbursement for automobile collision insurance damage claims, real property damage insurance claims, etc.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a functional block diagram that illustrates aspects of the present disclosure at a high level.

FIG. 3 is a block diagram that illustrates a payment system provided according to aspects of the present disclosure.

FIG. 4 is a block diagram that illustrates a computer system that may perform a role in the system of FIG. 3.

FIG. 4A is a block diagram that illustrates a point of interaction (POI) terminal that may perform a role in the system of FIG. 3.

FIG. 5 is a block diagram that illustrates a computer system that may perform a role in the system of FIG. 3.

FIGS. 6, 7 and 8 are flow charts that illustrate processes that may be performed in the system of FIG. 3 according to aspects of the present disclosure.

### DETAILED DESCRIPTION

In general, and for the purpose of introducing concepts of embodiments of the present invention, a service provider/merchant accepts a payment card or similar device at a point of interaction. The service provider initiates a payment card account system transaction for the amount due to be paid by a consumer/payment card account holder. In parallel, the point of interaction forwards, via another communication channel, to a supplemental processor, details of services provided to the consumer. The supplemental payment processor, in coordination with the card network, requests payment of a portion of the transaction amount from one or more insurers or other supplemental payment providers. (The supplemental payments, of whatever kind, may be referred to as “rebates”.) The request(s) for a rebate or rebates may be performed separately from the payment card account network rails and routing and processing facilities.

(In some contexts, the insurers/supplemental payment providers may be referred to as “insurance providers” or “rebate providers”.)

Upon receiving the rebate provider's authorization, the supplemental payment provider calculates a revised transaction amount, representing the original transaction amount less rebate(s). The card network forwards a revised payment card account system payment authorization request message to the issuer of the consumer's payment card account. The revised authorization request includes the revised transaction amount. The payment card account system transaction is completed to provide partial payment to the service provider. In a parallel or subsequent clearing transaction, the rebate(s) is(are) credited to the service provider.

With a system/process as described above, an insurance payment scheme or the like is largely automated and made convenient and efficient for all parties. Manual paper handling is minimized or eliminated, and the payment card account system communication channels are not overburdened with supplemental transaction details. Moreover, insurance companies or other rebate providers may become involved in an automated payment system with less expense and effort than may be required for data processing integration with a payment card network.

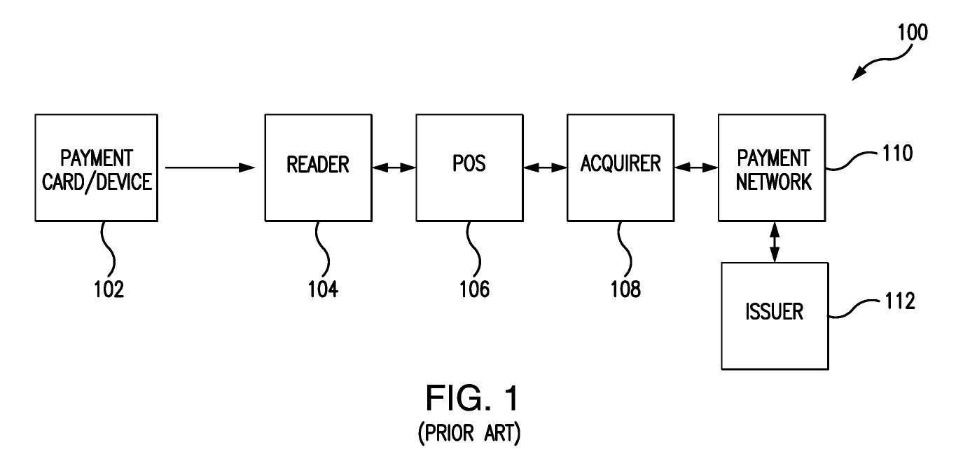

By way of background, a typical payment system will first be briefly described. FIG. 1 is a block diagram that illustrates a payment system 100.

The system 100 includes a payment card/device 102 (which may alternatively be a payment-enabled mobile device that stores a payment card account number and runs a payment applet; other form factors for the payment device, such as a fob, are also possible). The system 100 further includes a reader component 104 associated with a POS (point of sale) terminal 106. In some known manner (depending on the type of the payment card/device 102) the reader component 104 is capable of reading the payment card account number and other information from the payment card/device 102. (Some usages include the term “point of interaction” to include both the point of sale at a retail store, plus card acceptance terminals or the like at premises of service providers, transit system entrance gate terminals, etc.)

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate to receive an authorization request for the transaction from the POS terminal 106. The acquirer computer 108 may route the authorization request via a payment network 110 (sometimes also referred to as a “card network”) to the server computer 112 operated by the issuer of a payment card account that is associated with the payment card/device 102. An authorization response generated by the payment card issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment card issuer server computer 112 may be operated by or on behalf of a financial institution (“FI”) that issues payment card accounts to individual users and/or other entities. For example, the payment card issuer server computer 112 may perform such functions as (a) receiving and responding to requests for authorization of payment card account transactions to be charged to payment card accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment card issuers and their computers, a considerable number of acquirers and their computers, and numerous merchants and their POS terminals and associated proximity reader components. The system may also include a very large number of payment card account holders, who carry payment cards or other devices for initiating payment transactions by presenting an associated payment card account number to the reader component of a POS terminal.

A typical payment system like that shown in FIG. 1 may also handle other types of transactions, including online shopping transactions in which the purchaser submits a payment account number and related data to an e-commerce website-hosting computer.

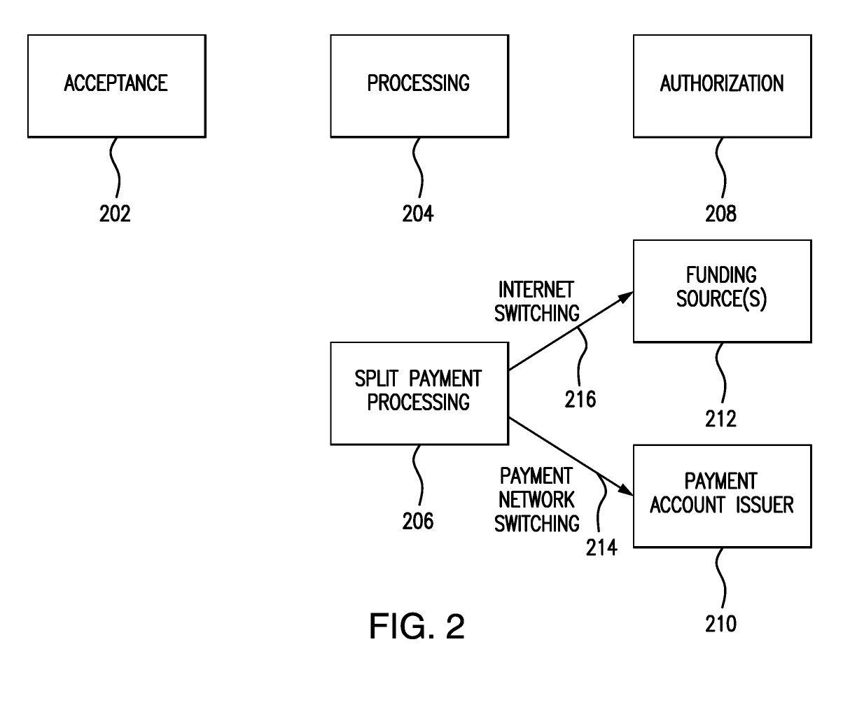

FIG. 2 is a functional block diagram that illustrates aspects of the present disclosure at a high level.

FIG. 2 lays out three broadly defined functions in as many columns. The first function is acceptance (block 202), which involves activities at the point of interaction (POI). As will be seen from more detailed description below, the POI activity may include inputting of a rather detailed description of services provided to a consumer by a service provider (e.g., a doctor or other medical services provider).

The second broad function is processing (block 204). Again, more detailed description below will discuss such processing as including split payment processing (block 206) to obtain payment for the transaction from two or more sources.

The third broad function is payment authorization (block 208). One source of such authorization may be a payment account issuer 210 (akin to item 112 in FIG. 1).

One or more other/supplemental funding sources (and hence sources of payment authorization) are indicated by block 212. The communication between the split payment processing function 206 and the payment account issuer 210 may be via payment card account network channels, as indicated at 214. The communication between the supplemental funding sources 212 and the split payment processing function 206 may be via internet switching/addressing, as indicated at 216.

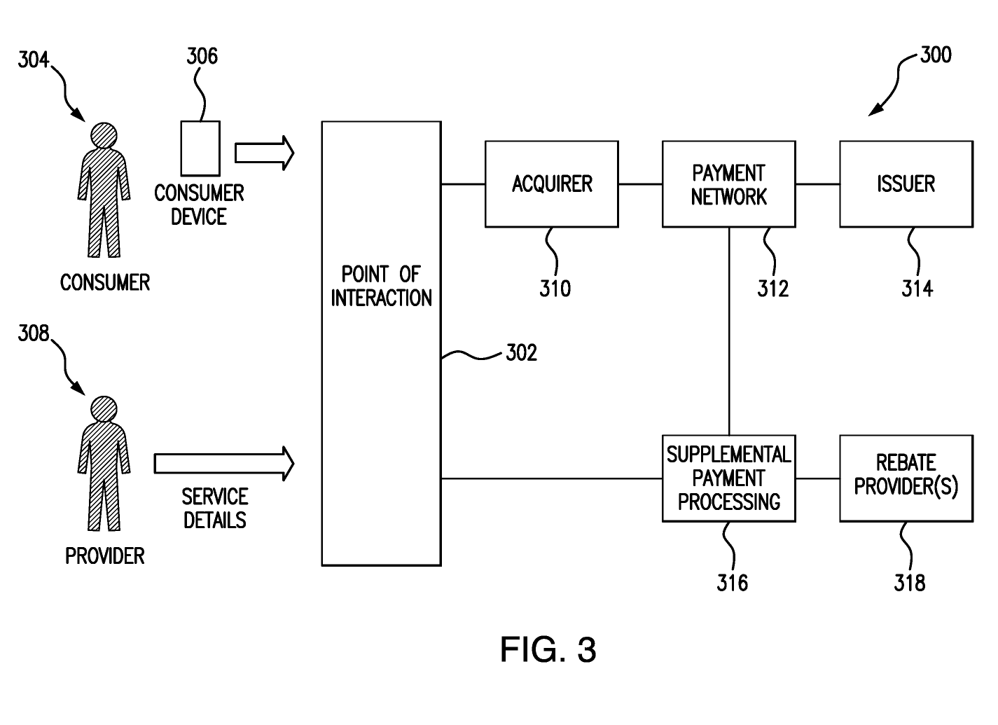

FIG. 3 is a block diagram that illustrates a payment system 300 provided according to aspects of the present disclosure.

The payment system 300 includes a point of interaction (POI) 302 at which a payment transaction is initiated. It is assumed that the POI 302 is located at the premises of a service provider, e.g., at a physician's office or a vehicle repair shop. The customer/consumer/payment account holder is indicated at 304. The consumer 304 is shown using a payment card/device 306 (akin to item 102 in FIG. 1) to provide account data (e.g., payment card account number or payment token, and related data) to the POI 302. That is, a reader component (not separately shown) of the POI 302 may read the account data from the consumer device 306. In subsequent discussion, it will at least sometimes be assumed that the account data includes a payment token. As is known to those who are skilled in the art, a payment token is a multi-digit number or other character string that stands in for the user's payment account number during a portion of the transaction process.

The service provider (or an employee thereof) is indicated at 308. The service provider 308 is shown inputting details of the service(s) provided to the POI 302. For example, in some embodiments, the service detail may include one or more standard insurance codes for identifying examinations, medical procedures, diagnoses and the like.

Also shown in FIG. 3 are an acquirer computer 310 (akin to item 108 in FIG. 1) and a payment network 312. The payment network 312 shown in FIG. 3 may perform the functions of the payment network 110 shown in FIG. 1, and additionally may operate to accommodate and facilitate rebate processing as described herein. Also shown in FIG. 3 is an issuer computer 314, which need not differ in its functionality from the issuer computer 112 discussed above in connection with FIG. 1.

The system 300 should be deemed to include the components 306, 310, 312 and 314 referred to above. The system 300 further includes a supplemental payment processing block 316. The supplemental payment processing block 316 may be closely associated (and/or under common operation) with the payment network 312. In other embodiments the supplemental payment processing block 316 may be provided and operated by an entity that is independent of the payment network. Details of the supplemental payment processing block 316 will be discussed below.

The system 300 further includes one or more rebate providers (block 318). By way of example, the rebate provider(s) 318 may be one or more insurance companies, such as medical insurance providers. Block 318 should also be deemed to represent one or more computers operated by the rebate provider(s).

In some embodiments, to facilitate communications between the supplemental payment processor 316 and the rebate provider(s) 318, the supplemental payment processor 316 may run a respective dedicated client software entity for each of the rebate providers 318. Each client entity may, as required, contact a server computer (not shown in FIG. 3 apart from block 318) at the URI that identifies that server. In this way, the supplemental payment processor 316 may provide outbound third party authorization APIs for the rebate providers 318.

As was the case with the system as depicted in FIG. 1, FIG. 3 only shows components required for handling a single transaction. In a practical embodiment of the system 300, there may be numerous POIs and consumer devices, a large number of acquirers and issuers, and potentially also a considerable number of rebate providers. There may also be more than one payment network and supplemental payment processing function.

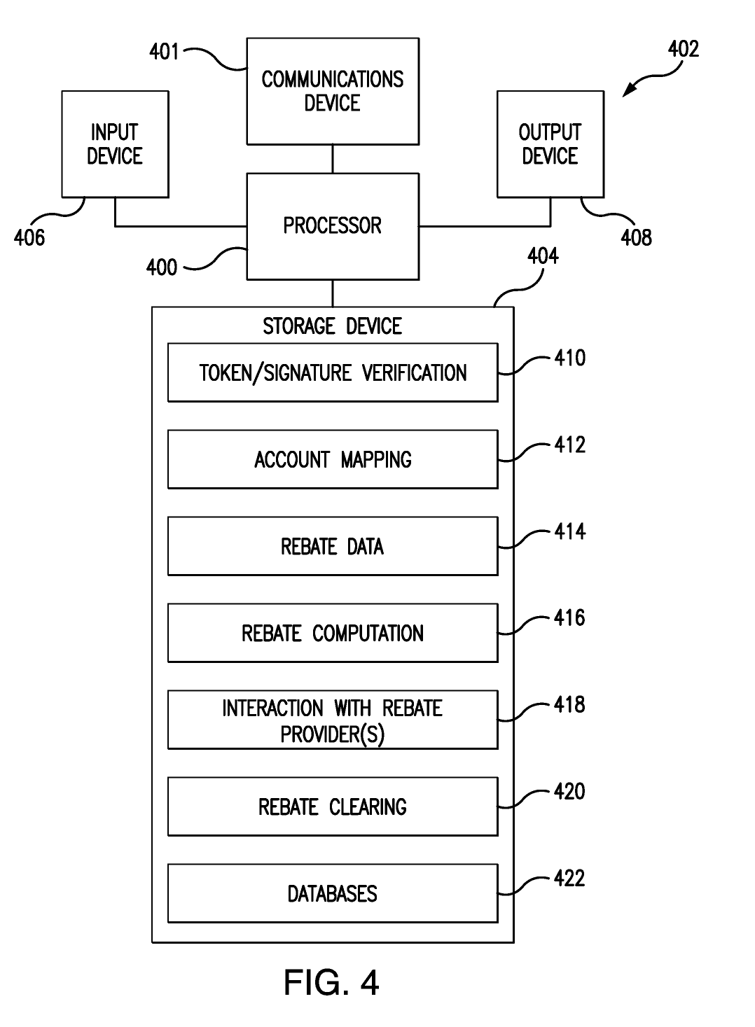

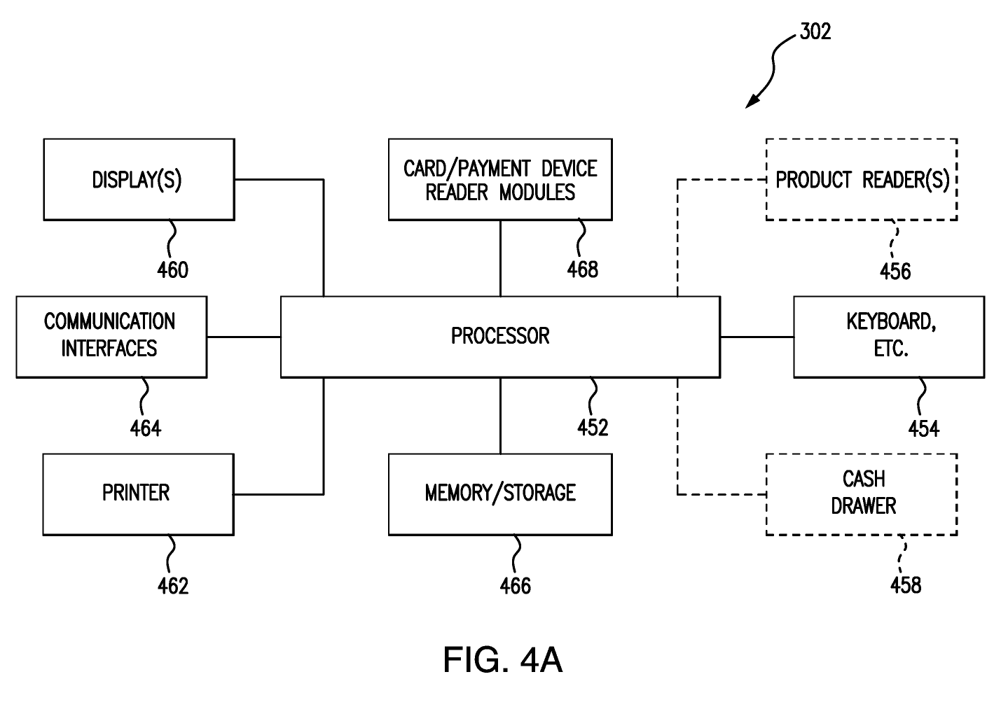

FIG. 4 is a block diagram that illustrates a computer system 402 that may implement and perform the functionality of the supplemental payment processing block 316. Accordingly, the computer system 402 may hereinafter be referred to as the supplemental payment processing computer 402.

Referring now to FIG. 4, the supplemental payment processing computer 402 may, in its hardware aspects, resemble a typical server computer and/or mainframe computer, but may be controlled by software to cause it to function as described herein. For example, the supplemental payment processing computer 402 may be constituted by commercially available server computer hardware and/or by cloud-based computing resources.

The supplemental payment processing computer 402 may include a computer processor 400 operatively coupled to a communication device 401, a storage device 404, an input device 406 and an output device 408. The communications device 401, the storage device 404, the input device 406 and the output device 408 may all be in communication with the processor 400.

The computer processor 400 may be constituted by one or more conventional processors. Processor 400 operates to execute processor-executable steps, contained in program instructions described below, so as to control the supplemental payment processing computer 402 to provide desired functionality.

Communication device 401 may be used to facilitate communication with, for example, other devices (such as one or more computers operated by the payment network 312, one or more computers operated by rebate provider(s) 318, and numerous POIs). For example (and continuing to refer to FIG. 4), communication device 401 may comprise numerous communication ports (not separately shown), to allow the supplemental payment processing computer 402 to communicate simultaneously with a number of other computers and other devices, including communications as required to simultaneously handle numerous payment transactions.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the supplemental payment processing computer 402, executed by the processor 400 to cause the supplemental payment processing computer 402 to function as described herein.

The programs may include one or more conventional operating systems (not shown) that control the processor 400 so as to manage and coordinate activities and sharing of resources in the supplemental payment processing computer 402, and to serve as a host for application programs (described below) that run on the supplemental payment processing computer 402.

The programs stored in the storage device 404 may also include a software module 410 for verifying tokens and digital signatures submitted in connection with transactions handled by the system 300.

The storage device 404 may also store a software module 412 for performing a mapping function that maps account numbers to relevant rebate providers.

Still further, the storage device 404 may store data structures 414 which may be employed to perform rebate computations, as described below.

Continuing to refer to FIG. 4, the storage device 404 may also store a rebate computation application program 416. The rebate computation may calculate rebates relevant to particular transactions, and may do so based on the above-mentioned rebate data 414.

Again continuing to refer to FIG. 4, the storage device 404 may additionally store a program 418 for managing interactions between the supplemental payment processing computer 402 and rebate provider(s) 318.

In addition, the storage device 404 may store a software module 420 for initiating clearing operations with respect to rebates authorized by the rebate provider(s) 318.

The storage device 404 may also store, and the supplemental payment processing computer 402 may also execute, other programs, which are not shown. For example, such programs may include a reporting application, which may respond to requests from system administrators for reports on the activities performed by the supplemental payment processing computer 402. The other programs may also include, e.g., one or more data communication programs, device drivers, etc.

The storage device 404 may also store one or more databases 422 required for operation of the supplemental payment processing computer 402.

FIG. 4A is a block diagram that illustrates an embodiment of the point of interaction (POI) 302 shown in FIG. 3. In some respects, the POI 302 may resemble a POS terminal such as the item 106 shown in FIG. 1. In other embodiments, the hardware making up the POI 302 may be a suitably programmed personal computer, laptop computer or tablet computer, with an associated card-reading peripheral or peripherals. The POI 302 may be programmed in accordance with aspects of the present disclosure to provide functionality as described herein.

Referring now to FIG. 4A, the POI 302 may include a processing element (or elements) such as the processor 452 shown in FIG. 4A. The processor 452 may, for example, be a commercially available microprocessor, and may operate to control the overall functioning of the POI 302.

The POI 302 may also include peripheral components, in communication with and/or controlled by the processor 452, such as: (a) a keyboard 454 for receiving input from the human operator of the POS terminal, together with other input devices (not separately shown, such as a numeric keypad, a mouse, and/or a touch screen); (b) a product reader 456 (shown in phantom, for some embodiments) for reading any form of unique product identifier, such as a barcode or RFID, that appears on, or is attached to, products brought to the POI 302 for purchase; (c) a cash drawer 458 (shown in phantom, for some embodiments) for storing cash received from customers; (d) one or more displays 460 for providing output (e.g., for supporting input of data by the service provider 308 (FIG. 3) and/or (in some embodiments) identifying products presented for purchase and their prices, indicating sales tax due, indicating transaction subtotals and totals, etc., providing prompts to the customer and/or to the service provider); (e) a printer 462 for printing out documents and/or sales receipts; and (f) a number of communication interfaces 464 for allowing the processor 452, and hence, the POI 302 to engage in communication over data networks with other devices (e.g., the acquirer 310 and the supplemental payment processing block 316, FIG. 3; and one or more other devices located on the premises of the service provider 308). In some embodiments, the communication interfaces may include respective interfaces suitable for communications via (a) a payment card account network; (b) the internet; and (c) local wired or wireless data networks.

In addition, the POI 302 may include one or more memory and/or data storage devices (indicated collectively at 466), which may comprise any combination of one or more of a hard disk drive, RAM (random access memory), ROM (read only memory), flash memory, etc. The memory/data storage device(s) 466 may store software and/or firmware that programs the processor 452 and the POI 302 to perform functionality as described herein. Thus the memory/data storage device(s) 466 may be in communication with the processor 452. Further, the POI 302 may include one or more housings (not shown) which contain and/or support one or more of the other components shown in FIG. 4A.

Further, the POI 302 may include one or more card/payment device-reader elements (block 468) such as a mag stripe reader, a contact IC card reader, a contactless IC card reader, NFC communications capabilities (for communicating with payment-enabled mobile devices), etc. The reader elements 468 may be in communication with the processor 452.

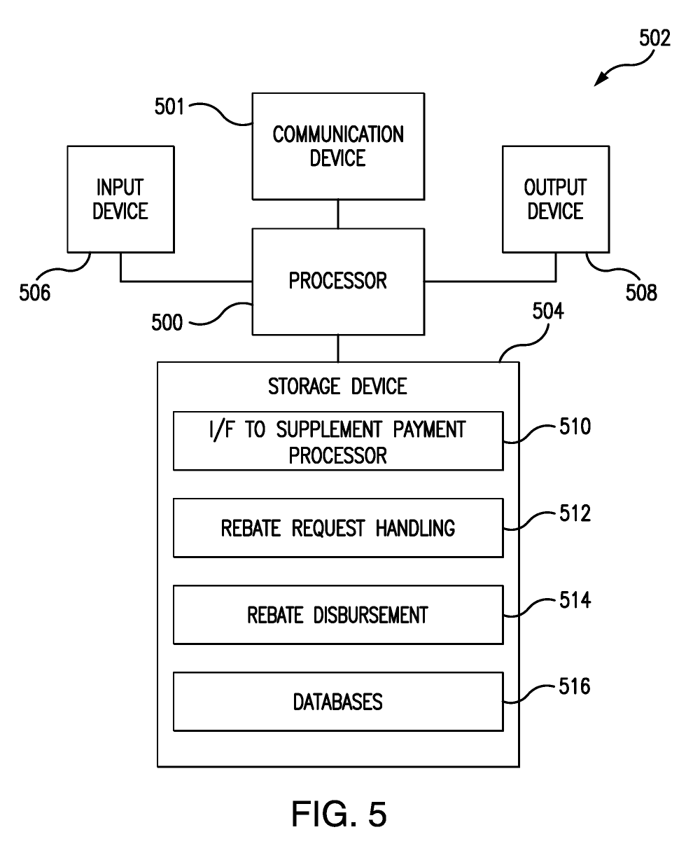

FIG. 5 is a block diagram that illustrates an embodiment of a computer system 502 that may be operated by one of the above-mentioned rebate providers 318 (FIG. 3). The computer system 502 accordingly may be referred to as a rebate provider computer. The rebate provider computer 502 may resemble the above-described supplemental payment processing computer 402 in terms of hardware architecture and/or constituent components. Accordingly, the rebate provider computer 502 may include a computer processor 500 operatively coupled to a communication device 501, a storage device 504, an input device 506 and an output device 508. The communications device 501, the storage device 504, the input device 506 and the output device 508 may all be in communication with the processor 500.

Processor 500 operates to execute processor-executable steps, contained in program instructions described below, so as to control the rebate provider computer 502 to provide desired functionality.

Storage device 504 stores one or more programs for controlling processor 500. The programs comprise program instructions (which may be referred to as computer readable program code means) that contain processor-executable process steps of the rebate provider computer 502, executed by the processor 500 to cause the rebate provider computer 502 to function as described herein.

The programs may include one or more conventional operating systems (not shown) that control the processor 500 so as to manage and coordinate activities and sharing of resources in the rebate provider computer 502, and to serve as a host for application programs (described below) that run on the rebate provider computer 502.

The programs stored in the storage device 504 may also include a software interface 510 for facilitating data communications between the rebate provider computer 502 and the supplemental payment processing computer 402.

The storage device 504 may also store a rebate request handling application program 512. The rebate request handling application program 512 may control the processor 500 to enable the rebate provider computer 502 to receive and respond appropriately to requests from the supplemental payment processing computer 402 that the rebate provider computer 502 authorize rebates as described herein.

Still further, the storage device 504 may store a rebate disbursement application program 514. The rebate disbursement application program 514 may control the processor 500 to enable the rebate provider computer 502 to disburse rebates that it has authorized in response to requests from the supplemental payment processing computer 402.

The storage device 504 may also store, and the rebate provider computer 502 may also execute, other programs, which are not shown. For example, such programs may include a reporting application, which may respond to requests from system administrators for reports on the activities performed by the rebate provider computer 502. The other programs may also include, e.g., one or more data communication programs, device drivers, etc.

The storage device 504 may also store one or more databases 516 required for operation of the rebate provider computer 502.

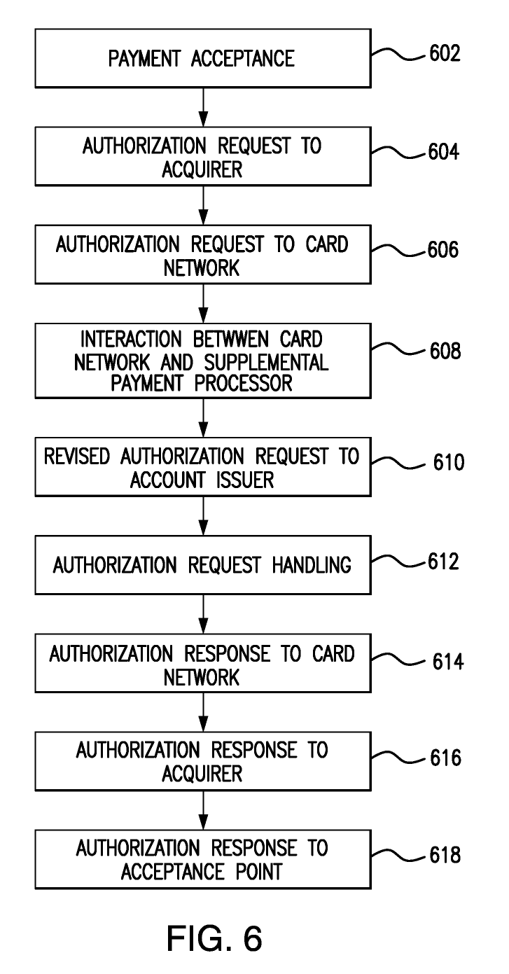

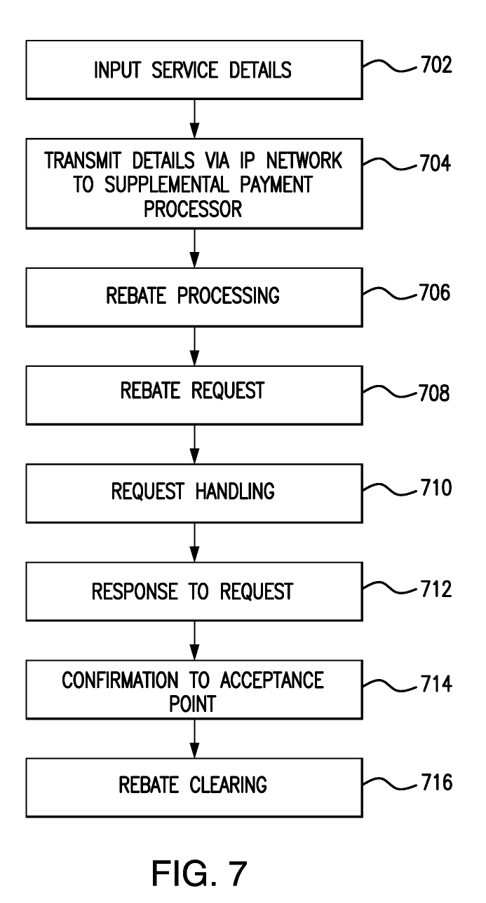

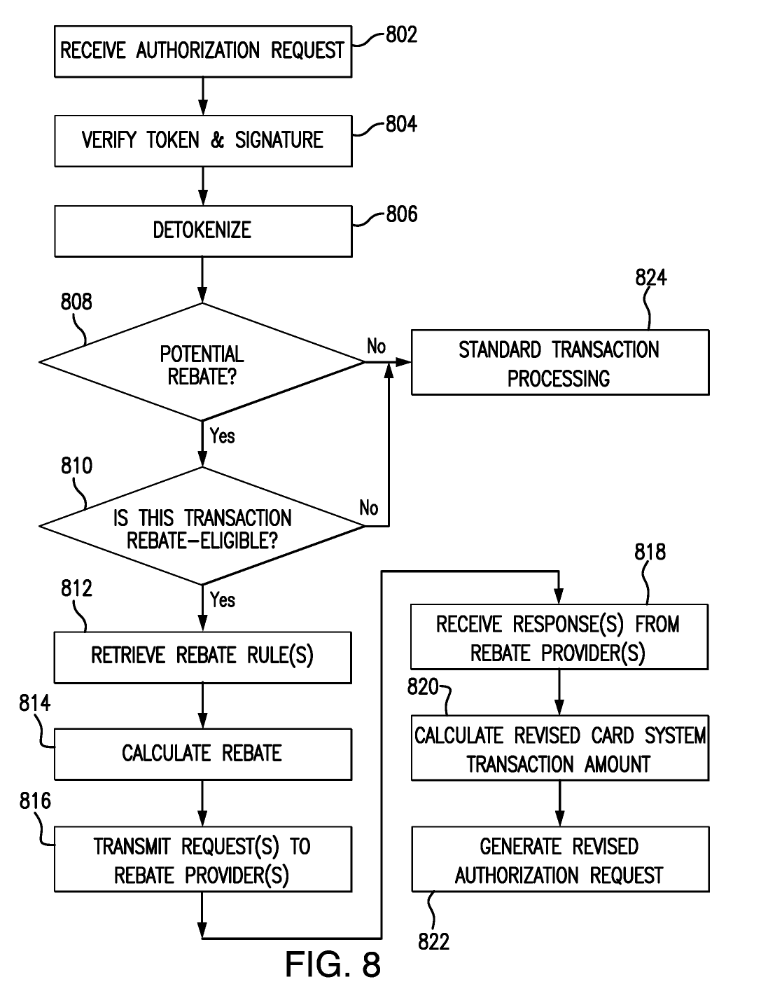

Processes that may be performed in the payment system 300 of FIG. 3 will now be described. FIG. 6, which will be discussed below in more detail, illustrates processing flow in the payment system 300 relating to payment card account system processing. FIG. 7, which will also be discussed hereinafter in more detail, relates to processing of supplemental payments. The process illustrated in FIG. 8 (also to be discussed hereinafter in more detail) may serve to knit together, and illustrate interrelationships between, the processing flows respectively illustrated in FIGS. 6 and 7.

Referring initially to FIG. 6, at block 602, the POI 302 (FIG. 3) accepts a payment transaction in the manner of payment card account system processing. The processing that occurs at 602 may include reading of a payment token from the consumer device 306 (FIG. 3), as well as calculation of a transaction amount by the POI 302, or inputting into the POI 302 of the transaction amount by the provider 308 and/or by receipt of data from another local device (not shown).

Continuing to refer to FIG. 6, at block 604, the POI 302 generates a payment card account system transaction authorization request message, and transmits that message (commonly known as an “authorization request”) to the acquirer 310 (FIG. 3). The processing by the POI 302 at 604 need not necessarily be different from a typical authorization request generation and transmission in a payment card account system, except that the authorization request may include a transaction identification number that may be subsequently employed for matching the payment card account system transaction with data related to supplemental payment processing, as described below. The authorization request may include the payment token read at 602, the transaction amount, merchant and/or terminal identification data, and other data typically included in a payment card account system authorization request. The authorization request may be in a standard format for such messages in the payment card account system and may be transmitted to the acquirer 310 via a communication channel dedicated for payment card account system communications.

It may have been the case, in connection with the interaction between the POI 302 and the consumer device 306 at block 602, that the consumer device 306 calculated a digital signature or cryptogram using the token and other transaction-related data as inputs, and then transmitted the digital signature or cryptogram to the POI 302. The cryptogram (e.g., an AC—“application cryptogram”) may be included in the authorization request as transmitted by the POI 302.

At 606, the acquirer 310 may transmit the authorization request to the payment network 312. This also may occur in a manner typical for transmission of authorization requests to a payment network that anchors a payment card account system.

At 608, the payment network 312 may receive the authorization request and may engage in an interaction with the associated supplemental payment processor 316. Prior to such interaction taking place, the payment network 312 may obtain translation of the payment token (included in the authorization request) into a corresponding PAN (primary account number).

At block 610 in FIG. 6, the payment network 312 may generate a revised authorization request (based on processing performed by the supplemental payment processor 316) and may route the revised authorization request to the issuer 314 (FIG. 3). The revised authorization request may include a revised (i.e., reduced) transaction amount, reflecting a rebate or rebates to be funded by one or more of the rebate providers 318. The revised authorization request may also include an account number (e.g., a PAN—primary account number) to which the payment token had been mapped. It will be appreciated that the account number may be used to route the revised authorization request and may identify the issuer 314 as the issuer of the payment account to which the consumer's payment for the transaction (net of rebate(s)) is to be charged.

At 612, the issuer 314 may handle the authorization request. The issuer's activity at 612 need not differ from a typical handling of an authorization request by an account issuer in a payment card account system. For example, the issuer may check the status of the consumer's account and the available balance or credit to confirm that authorization of the transaction is in order. Risk management processing may also occur.

At 614, the issuer 314 may transmit the payment card account system transaction authorization response message (typically referred to as an “authorization response”) to the payment network 312, and the payment network 312 may receive the authorization response. The authorization response may be in a standard format for such messages as defined for the payment card account system.

At 616, the payment network 312 may route the authorization response to the acquirer 310, and the acquirer 310 may receive the authorization response. At 618, the acquirer 310 may transmit the authorization response to the POI 302 and the POI 302 may receive the authorization response.

Referring now to FIG. 7, at 702, the service provider 308 may provide—to the POI 302—details of the service(s) that may been provided (e.g., medical treatments, tests, etc.) to the consumer 304 by the service provider 308. For example, these details may be medical procedure/treatment codes or the like. The service details may be directly input by the service provider via the user interface of the POI 302. In addition or alternatively, another local device (not shown) may communicate the service details to the POI 302 via data communications. For example, in the case of a physician, the physician may enter details of treatment or examination, etc. into a medical office IT system (not shown), which may in turn communicate the service details in appropriate format to the POI 302.

At 704, the POI 302 may transmit the service details to the supplemental payment processor 316. The messaging to the supplemental payment processor 316 may include a transaction number that can be used to link the service details to the payment card account system transaction discussed in connection with FIG. 6. The transmission of the service details to the supplemental payment processor 316 may be via the internet or another network in which communication occurs in accordance with conventions of the Internet Protocol (IP) and/or in which device addressing is by URI (Uniform Resource Identifier). A transmission or message via a network or network of these types should be deemed an “internet protocol message”.

At 706, the supplemental payment processor 316 may perform rebate processing in a manner to be described in more detail below in connection with FIG. 8. The rebate processing may be based on the service details received by the supplemental payment processor 316 at 704 and also based on data obtained from the payment card account system messaging as referred to above in connection with FIG. 6.

At 708, the supplemental payment processor 316 may generate at least one rebate request. The supplemental payment processor 316 also may transmit the rebate request(s) to each appropriate respective rebate provider 318. At 710, the rebate provider 318 (for each rebate request) may handle the request. This may involve determining whether the requested rebate is in fact properly payable by the rebate provider in question.

At 712, the rebate provider 318 (for each rebate request) may transmit a response to the supplemental payment processor 316 concerning the requested rebate. Then, at 714, the supplemental payment processor 316 may send a confirmation to the POI 302 concerning the rebate(s) requested by the supplemental payment processor 316. Again, this communication may be via an IP network such as the internet. It may also be the case that the communication between the supplemental payment processor 316 and the rebate provider(s) 318 may be via the internet or other IP network.

At 716, the supplemental payment processor 316 may manage/oversee clearing of the requested rebates. This may involve clearing funds transfer(s) from a bank or banks that serve the rebate provider(s) 318 to the service provider's bank for the benefit of the service provider.

Reference will now be made to FIG. 8. FIG. 8 illustrates processing that may occur entirely or primarily at and/or by the supplemental payment processor 316.

At 802 in FIG. 8, the supplemental payment processor 316 receives the authorization request (as referred to, e.g., at 606 in FIG. 6); alternatively, the supplemental payment processor 316 may receive selected data contained in the authorization request.

At 804, the supplemental payment processor 316 (or a token service provider function associated therewith, and not separately shown) may perform standard measures to verify that the token and an accompanying cryptogram are valid.

At 806, the supplemental payment processor 316 (or a token service provider function associated therewith) may convert the token into a PAN, e.g., by reference to a token vault that maps tokens to PANs. It will be appreciated that the PAN obtained at 806 identifies a payment card account that has been issued to the consumer 304.

A decision block 808 may follow block 806. At decision block 808, the supplemental payment processor 316 may determine whether, based on the PAN obtained at 806, it is possible that a rebate may be payable in connection with the payment card account system transaction. This may be done, for example, by mapping the PAN to a rebate provider (such as e.g., a medical insurance company that has issued medical insurance coverage to the consumer 304). For example, in order to perform such a mapping, the supplemental payment processor 316 may refer to a database that associates PANs with medical insurance companies or other rebate providers that have obligations to provide supplemental payments to benefit the consumers associated with the PANs.

In some embodiments, the mapping to rebate providers may, in at least some cases, be based on tokens rather than PANs.

If a positive determination is made at decision block 808 (i.e., if the supplemental payment processor 316 determines that at least one rebate provider is associated with the PAN obtained at 806), then decision block 810 may follow decision block 808. At decision block 810, the supplemental payment processor 316 may determine, according to rules applicable to the rebate provider(s) in question, whether the current payment card account system transaction is eligible for a rebate. This determination may, for example, be based on factors such as the identity of the service provider (e.g., as indicated by a merchant i.d., and/or merchant category code contained in the authorization request) and/or based on the nature of the services provided, as described in the service details received by the supplemental payment processor 316 at 704 in FIG. 7.

If a positive determination is made at decision block 810 (i.e., if the supplemental payment processor 316 determines that the transaction in question is eligible for a rebate), then block 812 may follow decision block 810. At block 812, the supplemental payment processor 316 may retrieve one or more rules for calculating the amount of the rebate that applies to the transaction. (It may be the case, at decision block 810, that the supplemental payment processor 316 determines that more than one rebate applies to the current transaction. If this is so, then this processing step and following steps may be performed by the supplemental payment processor 316 with respect to each rebate for which the transaction is eligible.)

At 814, the supplemental payment processor 316 calculates the rebate based on the rule(s) retrieved at 812. To give one example, and assuming that the services provided were at a visit to a physician's office, the rule may indicate that a rebate of 80% of the office visit charge is payable from medical insurance company A. To extend the example, and assuming that additional medical insurance coverage from medical insurance company B applies, then a rule applicable to the latter rebate may indicate that a rebate is payable from medical insurance company B for the balance of the office visit charge.

At 816, the supplemental payment processor 316 may submit a request to a respective rebate provider 318 for each rebate calculated at 814. Communications between the supplemental payment processor 316 and the rebate provider 318 may be via one or more suitable APIs (application program interfaces) and/or via other data communication arrangements such as client/server interactions via the internet.

At 818, the supplemental payment processor 316 receives—from the rebate provider(s) 318—a response or responses to the request(s) transmitted at 816. Assuming the response(s) indicate(s) that the rebate(s) (is)are authorized by the rebate provider(s), then at block 820 the supplemental payment processor 316 may calculate a revised transaction amount. This calculation may include subtracting—from the original transaction amount—the amount of the rebate (if only one rebate applies) or the sum of the amounts of the rebates (if two or more rebates apply).

It will be noted that via the mapping of PAN (or token) to rebate provider(s), and submission of rebate requests thereto, the supplemental payment processor 316 effectively performs a switching function with respect to supplemental payment/rebate administration in the system 300.

At 822, the supplemental payment processor 316 (or the payment network 312, based on input from the supplemental payment processor 316) may generate a revised authorization request that includes the revised transaction amount as the transaction amount to be submitted to the account issuer 314. From this point, the payment card account system transaction may resume, as discussed in connection with block 612 and the following blocks in FIG. 6.

In the event that a negative determination is made at decision block 808 or 810, the process of FIG. 8 may advance to block 824. At block 824, the processing of the payment card account transaction is allowed to proceed in a typical fashion, i.e., without application of a rebate and without revision to the authorization request as received by the payment network 312.

With a payment system as described in FIGS. 2-8, supplemental payment processing in an automated fashion may take the place of inefficient and labor-intensive reimbursement schemes. As suggested above, one possible application for such a payment system is for implementing medical insurance funding of at least a portion of a consumer/insured's medical expenses. Another possible application for such a system would be for insurance funding of insurance-covered motor vehicle repairs. In an application of this type, one or more property/casualty insurers may be among the rebate providers 318 indicated in FIG. 3. Another potential application would pertain to building repairs covered by homeowner's insurance.

Still another possible application of the payment system 300 may be for VAT (value added tax) refund/exemption processing for purchases by travelers in countries that apply VAT to their own citizens but not to eligible purchases by visitors. In such a case, the “service provider” as depicted in FIG. 3 may instead be a merchant selling goods for which VAT reimbursement/exclusion is applicable.

In yet another possible application of the payment system 300, the rebate provider may be a government agency that subsidizes purchase of food items or medicines for low-income individuals. Again, in this application, the POI 302 may be operated by a merchant that sells goods eligible for subsidy via a government benefit.

In the process of FIG. 8, as described above, the supplemental payment processor 316 calculates the rebate amounts and submits requests accordingly (in effect for confirmation/authorization) by the rebate providers. In other embodiments, or for some of the rebate providers, the supplemental payment processor 316 may submit the necessary data to the rebate providers to allow the rebate providers to calculate the rebate amounts, which are then provided to the supplemental payment processor 316 from the rebate providers. That is, in some embodiments or in some situations, the supplemental payment processor 316 need not function to calculate rebate amounts.

In the above description, particularly with reference to FIGS. 6 and 8, it has been assumed that rebate processing was performed in parallel with payment card system messaging, and was completed rapidly enough to allow the revised payment card system transaction amount to be inserted into a revised authorization request (per blocks 820 and 822), for routing from the payment network 312 to the payment account issuer 314. However, if the rebate processing is not sufficiently rapid for this to occur, then the transaction authorization request with the original transaction amount may be routed from the payment network 312 to the payment account issuer 314, and an event may be logged to indicate that further action is to be taken. Thereafter, when the rebate processing is complete, and if it indicates one or more rebates are payable with respect to the transaction, then a suitable advice message may reverse the payment card system transaction and another payment card system transaction may be performed, reflecting the revised transaction amount in view of rebate(s) payable.

The system 300 as depicted in FIG. 3 may be generalized/expanded in a number of ways within the contemplation of teachings of the present disclosure. As already suggested, for a given consumer and a given transaction, the consumer may have contractual rights or other entitlement(s) to receive at least partial funding from a number of different rebate providers. It may also be the case that the services provided by the service provider were at least in part supplied by one or more entities in subcontractor relationships with the service provider. To protect the interests of the subcontractors, the functionality of the supplemental payment processor may be extended to split-disbursement functions. That is, funding from the consumer's (residual) payment card account system transaction, as well as funding from plural rebate providers, may be distributed among the service provider and its subcontractors according to contractual arrangements among those parties. The contractual arrangements may be reflected in disbursement rules administered by the supplemental payment processor/split disbursement processor according to a split and rebate algorithm and an repartition algorithm.

Referring again to the payment system 300 of FIG. 3, in some embodiments, upon completion of the transaction at the POI 302 (i.e., upon the POI 302 receiving the payment card account system authorization response and the confirmation referred to at 714 in FIG. 7), the POI 302 may print out a transaction receipt for the consumer 304. In addition or alternatively, the POI 302 may transmit the receipt in electronic form to a device owned or accessible by the consumer 304. The receipt may indicate both (a) the amount charged for the transaction to the consumer's payment account; and (b) the amount(s) of a rebate or rebates applied to the transaction, including identification of the source(s) of the rebate(s).

In the payment system 300 as portrayed in FIG. 3, the consumer 304 interacts with the POI 302 to trigger the POI 302 transmitting an authorization request message through the payment card system. There are, however, alternative ways for the authorization request to be initiated. For example, the consumer device 306 (which may be a smartphone) may obtain transaction data from the POI 302, and then may communicate over-the-air with a payment gateway (not shown) or virtual POS (not shown) on the internet. The payment gateway or virtual POS may then generate an authorization request message and transmit the message, e.g., to the payment network 312. In this scenario, one way in which the consumer device 306 may obtain transaction data from the POI 302 may be by scanning a QR code displayed on a display component of the POI 302. The over-the-air communications by the consumer device 306 may be in-app or via a mobile browser.

The POS 302, as described above herein, may resemble a conventional point-of-sale terminal in many respects. Alternatively, however, the POS 302 may be constituted by a suitably programmed mobile device, such as a tablet computer. An embodiment of the POS 302 of the latter type may be conducive to supporting both payment system messaging as well as the internet-based communications also described with respect to the payment system 300. With a POI embodied as a mobile device, and equipped with a digital camera (as many mobile devices are), the service details may be input to the POI 302 by presenting to it a QR code or other suitable barcode, to be scanned/read by the POI 302.

To facilitate the establishment and/or roll-out of the payment system 300, a software development kit (SDK) may be made available to encourage and support suitable programming of the POIs (only one shown) to incorporate therein functionality such as that described herein.

Embodiments described above have been primarily been illustrated with the assumption that rebates were provided in the form of medical expense reimbursements with the insurance provider(s)/rebate provider(s) being medical insurance companies, government medical benefit providers, or the like. However, the teachings of this disclosure are also applicable to other contexts, such as (a) rebates/insurance reimbursements for motor vehicle repairs provided under motor vehicle collision or comprehensive insurance coverage or motor vehicle warranty coverage; (b) building/home repairs covered under real property damage insurance coverage; (c) repairs to home appliances under insurance and/or warranty programs, and so forth.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “transaction processor” refers to a transaction acquirer or other entity that performs at least some functions of a transaction acquirer.

The terms “insurance provider” and “rebate provider” are used interchangeably herein.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
engaging in a payment card account system transaction at a provider;
first transmitting a payment card account system transaction authorization request message from the provider to a transaction processor with respect to the transaction; and
second transmitting details of the transaction via an internet protocol message from the provider to a rebate processor.

2. The method of claim 1, wherein:
the provider is a medical provider; and
the details of the transaction describe medical treatment provided by the provider to the account holder.

3. The method of claim 1, wherein:
the provider is a motor vehicle repair shop; and
the details of the transaction describe repairs performed by the provider on an account holder's motor vehicle.

4. The method of claim 1, wherein the payment card account system transaction includes the provider reading payment card account data from an account holder's payment device.

5. The method of claim 4, wherein the payment device is an IC (integrated circuit) payment card.

6. The method of claim 1, further comprising:
the provider providing a transaction receipt to a consumer, the transaction receipt indicating (a) an amount charged to the consumer's payment account in connection with the payment card account system transaction; and (b) at least one rebate calculated based on said transmitted details of the transaction.

7. A method comprising:
receiving a payment card account system transaction authorization request message via a first communication channel, the payment card account system transaction authorization request message relating to a transaction;
determining that the transaction requires rebate processing;
receiving details of the transaction via a second communication channel different from the first communication channel;
processing the received details of the transaction to generate a rebate request;
transmitting the rebate request to a rebate provider;
receiving a response from the rebate provider;
based at least in part on (a) the received payment card account system transaction authorization request message and (b) the response from the rebate provider, generating a revised transaction authorization request message; and
routing the revised transaction authorization request message to an issuer of a payment account that belongs to an account holder.

8. The method of claim 7, wherein:
the second communication channel is an internet protocol channel; and
the first communication channel is a payment card account network communication channel.

9. The method of claim 7, wherein the details of the transaction describe at least one medical treatment provided to the account holder.

10. The method of claim 7, wherein the details of the transaction describe at least one repair performed on a motor vehicle owned by the account holder.

11. The method of claim 7, wherein:
the payment card account system transaction authorization request message includes a first transaction amount;
the revised transaction authorization request message includes a second transaction amount; and
the second transaction amount is less than the first transaction amount.

12. The method of claim 7, wherein:
the rebate request is a first rebate request; and
the rebate provider is a first rebate provider;
the method further comprising:
processing the received details of the transaction to generate a second rebate request different from the first rebate request; and
transmitting the second rebate request to a second rebate provider different from the first rebate provider.

13. The method of claim 12, wherein:
the first rebate provider is a first medical insurer; and
the second rebate provider is a second medical insurer.

14. The method of claim 7, wherein said determining is based at least in part on said received details of the transaction.

15. The method of claim 7, wherein said determining is based at least in part on a payment card account indicator included in said payment card account system transaction authorization request message.

16. An apparatus comprising:
a processor; and
a memory in communication with the processor, the memory storing program instructions, the processor operative with the program instructions to perform functions as follows:
receiving a payment card account system transaction authorization request message via a first communication channel, the payment card account system transaction authorization request message relating to a transaction;
determining that the transaction requires rebate processing;
receiving details of the transaction via a second communication channel different from the first communication channel;
processing the received details of the transaction to generate a rebate request;
transmitting the rebate request to a rebate provider;
receiving a response from the rebate provider;
based at least in part on (a) the received payment card account system transaction authorization request message and (b) the response from the rebate provider, generating a revised transaction authorization request message; and
routing the revised transaction authorization request message to an issuer of a payment account that belongs to an account holder.

17. The apparatus of claim 16, wherein:
the second communication channel is an internet protocol channel; and
the first communication channel is a payment card account network communication channel.

18. The apparatus of claim 16, wherein the details of the transaction describe at least one medical treatment provided to the account holder.

19. The apparatus of claim 16, wherein the details of the transaction describe at least one repair performed on a motor vehicle owned by the account holder.

20. The apparatus of claim 16, wherein:
the payment card account system transaction authorization request message includes a first transaction amount;
the revised transaction authorization request message includes a second transaction amount; and
the second transaction amount is less than the first transaction amount.
